(19) United States
(12) Patent Application Publication
(10) Pub. No.: US 2007/0215773 A1
(43) Pub. Date: Sep. 20, 2007

(54) Mounting bracket assembly

(76) Inventor: Jack Russell Kerr JR., College Station, TX (US)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(21) Appl. No.: 11/712,999

(22) Filed: Mar. 2, 2007

Related U.S. Application Data
(60) Provisional application No. 60/778,176, filed on Mar. 2, 2006.

(51) Int. Cl. B42F 13/00

(52) U.S. Cl. 248/343

(57) ABSTRACT

A mounting bracket assembly for hanging a heavy object in a ceiling area comprises a support bar and a clamping component. The support bar telescopes to span a distance between a pair of spaced joists, includes two tubular members which have axes that are parallel and are oriented side-by-side, and an end-plate at each end of the support bar. An overlay for each end-plate includes circular bosses to hold and align preset fasteners, and a slide to adjust the height of the end-plate. The clamping component includes a clamping bar, and at least one fastener that attach the clamping bar to an electrical junction box. When a portion of the support bar is positioned between the clamping bar and the electrical junction box, tightening the fastener that attaches the clamping bar to the electrical junction box will secure the electrical junction box to the support bar.

### CROSS-REFERENCE TO A RELATED APPLICATION

This application for letters patent is related to and incorporates by reference provisional application for patent serial number 60/778,176, titled “Mounting Bracket ” and filed in the United States Patent and Trademark Office on Mar. 2, 2006.

### BACKGROUND OF THE INVENTION

1. Field of the Invention

This invention relates to a mounting bracket assembly for an electrical fixture. In particular, the invention is a mounting bracket assembly for installing an electrical fixture in a ceiling.

2. Description of the Prior Art

An electrical junction box provides a safe enclosure for the electrical wiring that powers an electrical device. For an electrical device hanging from a ceiling, such as a ceiling fan or light fixture, the electrical junction box typically spans between two spaced beams, joists, studs, or the like. A mounting bracket assembly provides the support necessary to suspend the electrical junction box between the two spaced beams, joists, studs, or the like.

In existing construction where the ceiling is finished drywall, it is desirable for the installer of a ceiling fan or light fixture to minimize or eliminate damage to the remainder of the finished drywall. Typically, the installer can snake the electrical supply wiring through the walls and the ceiling without damaging the finished drywall however, installing the mounting bracket assembly without damaging the finished drywall in more difficult. It is desirable for the installer to make a hole in the finished drywall the size of the electrical junction box and install the mounting bracket assembly through the hole.

Additionally, the installation of a ceiling fan or light fixture can be an awkward and cumbersome task, especially when performed by a single individual. Often, the installer must work atop a ladder and may not have both hands free to perform the task. A mounting bracket assembly can improve the task of installation of a fixture by making the process easier, more convenient, and save time and expense.

There is a demand for a mounting bracket assembly that provides greater strength, telescopes to accommodate a span between 14 and 26 inches between two spaced beams, joists, studs, or the like, accommodates various thicknesses of finished drywall, and simplifies the installation process. Consumers have a strong interest in new installation projects due to new home construction, the renovation of existing homes, and seek more choice in the selection of electrical lighting and fan fixtures in the marketplace. Likewise, consumers have a strong interest in doing these renovations on their own, rather than hiring a contractor, to save money. The presently disclosed mounting bracket assembly satisfies these demands.

### SUMMARY OF THE INVENTION

A mounting bracket assembly for hanging a heavy object in a ceiling area comprises a support bar and a clamping component. The support bar spans a distance between a pair of spaced joists. The support bar includes two tubular members which have axes that are parallel and which are oriented side-by-side, an inner member, an outer member, and a pair of end-plates. An inside diameter of each tubular member of the outer member of the support bar is greater than an outside diameter of each tubular member of the inner member of the support bar. This allows the tubular members of the outer member of the support bar to receive the tubular members of the inner member of the support bar and enables the support bar to telescope along its lateral axis. One end-plate is located at one end of the inner member and has a surface plane that is substantially perpendicular to a lateral axis of the inner member. The other end-plate is located at one end of the outer member and has a surface plane that is substantially perpendicular to a lateral axis of the outer member. At least two fasteners pass through openings in each end-plate to attach the support bar to the pair of spaced joists. The clamping component includes a clamping bar, and at least one fastener that pass through an opening in the clamping bar and an opening in an electrical junction box. A portion of the support bar is positioned between the clamping bar and the electrical junction box so that tightening said at least one fastener that passes through the opening in the clamping bar will secure the electrical junction box to the support bar.

If the electrical junction box is fabricated from metal, the inside walls of the tubular members includes grooves that receive the sides of a U-shaped clamping bar and a space between the tubular members receive the fasteners that pass through the openings in the clamping bar. This configuration of the clamping bar and tubular members allows the clamping bar to slide along a lateral axis of the support bar.

If the electrical junction box is fabricated from plastic or PVC, the electrical junction box includes a channel in the upper wall. The channel includes two shallow side walls and a lower wall. The shallow side walls are perpendicular to the lower wall. The lower surface of the lower wall of the channel is above the lower plane of the electrical junction box to form a cavity under the lower wall of the channel for housing electrical connections in the electrical junction box. The width and depth of the channel are sufficient to receive the support bar and the clamping bar wherein the support bar is positioned between the clamping bar and the lower wall of the channel.

Each end-plate may include an overlay. The overlay includes an opening for receiving the inner member or the outer member of the support bar, and an opening for receiving each fastener that attaches the support bar to the pair of spaced joists. The overlay may also include a circular boss around the opening for receiving each fastener for holding the fastener and aligning the fastener with the opening in the end-plate thereby simplifying the attachment of the support bar to the pair of spaced joists. The overlay may also include a slide and guides for adjusting the height of the end-plate and electrical junction box above the finished sheetrock. The slide includes a left vertical member, a right vertical member, a horizontal member connecting an upper end of the vertical members, and at least two sets of slots in the upper end of the vertical members, each set of slots including a left slot in the left vertical member and a right slot in the right vertical member. The guides are positioned at a lower edge of the overlay to receive the vertical members of the slide. Two notches positioned near an upper edge of the overlay are positioned to insert into one of the sets of slots in the vertical members of the slide. Inserting the two notches into a lower of the sets of slots disengages the slide thereby using a standard height end-plate, while inserting the two notches into an upper of the sets of slots engages the slide thereby increasing the height of the end-plate.

### BRIEF DESCRIPTION OF THE DRAWINGS

FIG. 1 is an isometric top-view of an exemplary embodiment of the mounting bracket assembly of the present invention.

FIG. 2 is an exploded view of the mounting bracket assembly shown in FIG. 1.

FIG. 3 is a side elevation of the clamping component of the mounting bracket assembly shown in FIG. 1.

FIG. 4 is a side elevation of the end-plates of the mounting bracket assembly shown in FIG. 1.

FIG. 5 is a top view of the clamping component of the mounting bracket assembly shown in FIG. 1.

FIG. 6 is an exploded view of the clamping component shown in FIG. 5.

FIG. 7 is an isometric top-view of an exemplary embodiment of the mounting bracket assembly of the present invention.

FIG. 8 is an exploded view of the mounting bracket assembly shown in FIG. 7.

FIG. 9 is a side elevation of the clamping component of the mounting bracket assembly shown in FIG. 7.

FIG. 10 is a top view of the clamping component of the mounting bracket assembly shown in FIG. 7.

FIG. 11 is a side elevation of the clamping component shown in FIG. 10.

FIG. 12 is a bottom view of the clamping component shown in FIG. 10.

FIG. 13 is an exploded view of the clamping component shown in FIG. 12.

FIGS. 14-17 are side elevations of the height adjustable mechanism attached to the telescoping dual tubular support bar near the end-plates of the mounting bracket assembly shown in FIG. 7.

FIGS. 18-19 are exploded views of the height adjustable mechanism shown in FIGS. 14-17.

FIG. 20 is an isometric top-view of the mounting bracket assembly shown in FIG. 1.

FIG. 21 is an isometric top-view of the mounting bracket assembly shown in FIG. 7.

### DETAILED DESCRIPTION OF THE INVENTION

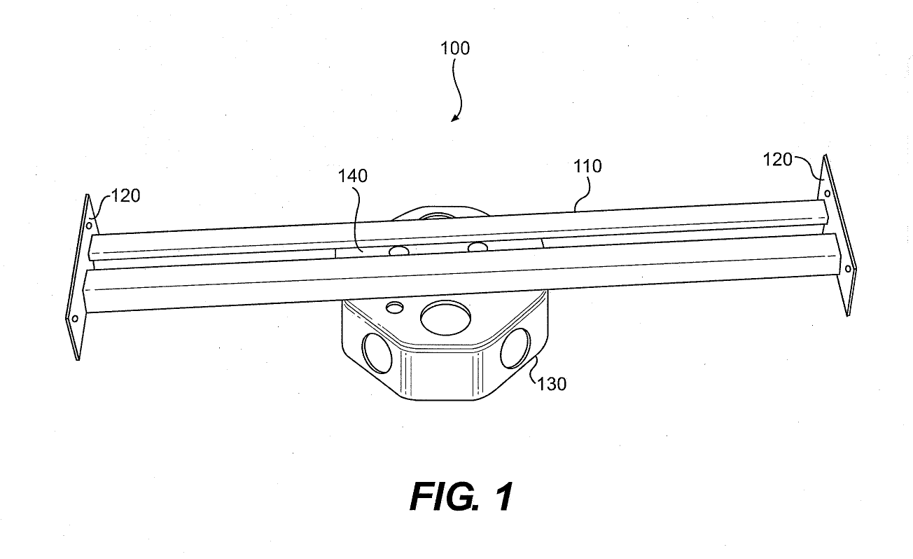

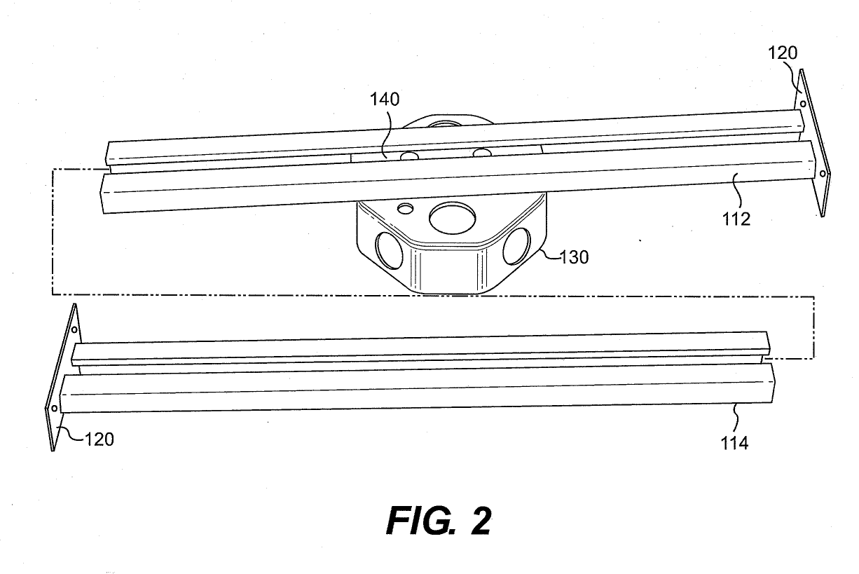

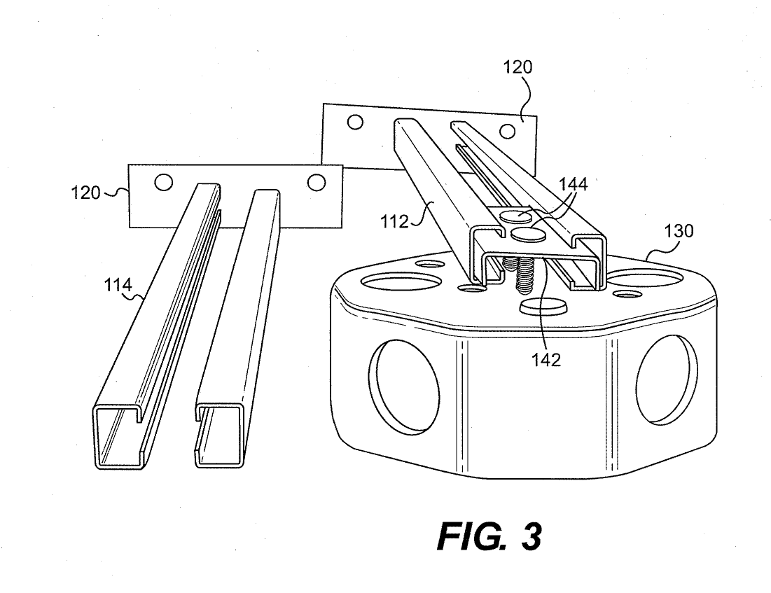

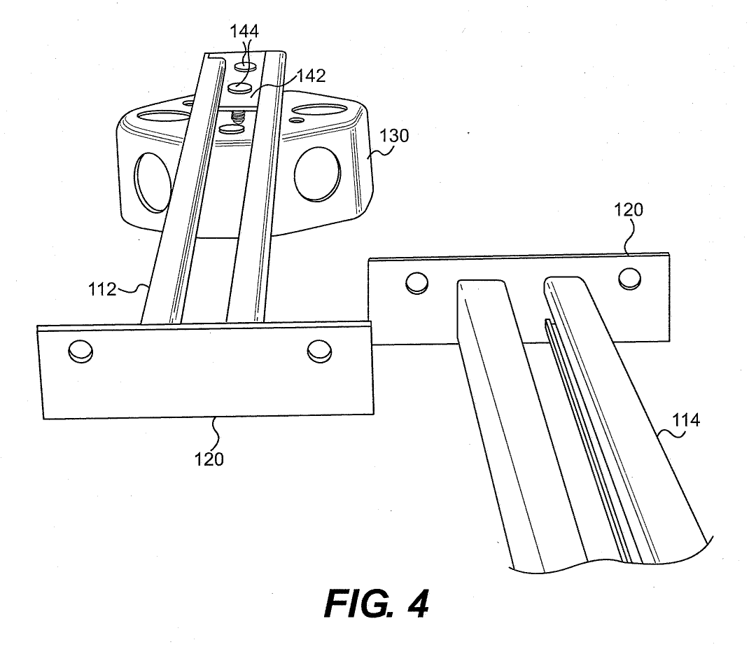

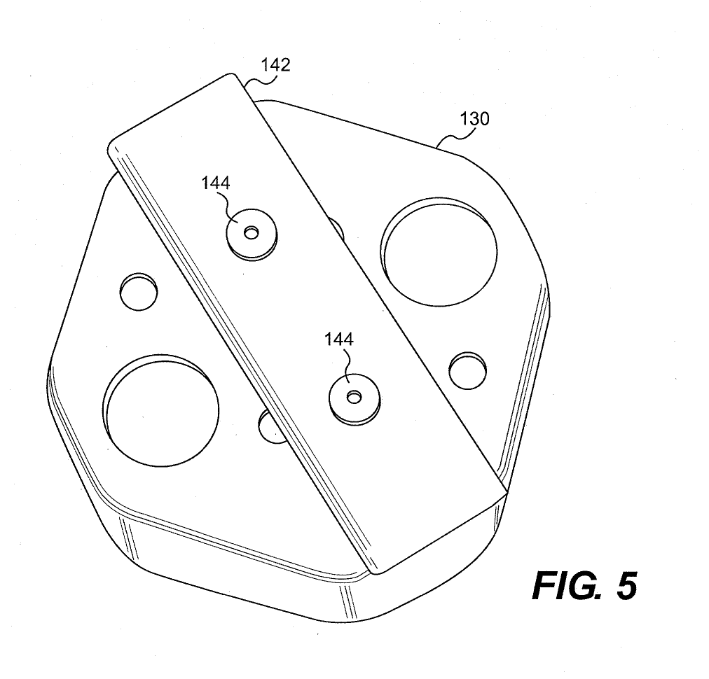

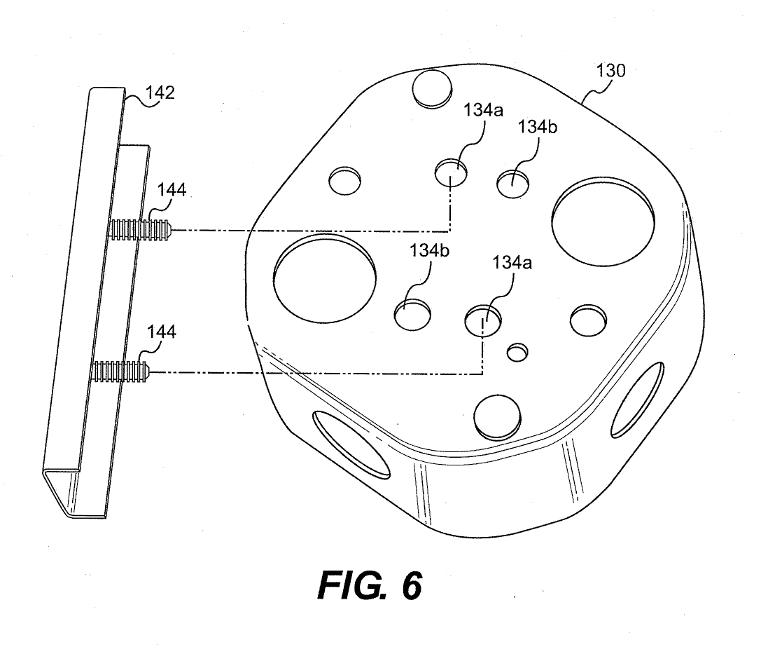

FIGS. 1-6 illustrate a first exemplary embodiment of the mounting bracket assembly of the present invention. As shown in FIG. 1, a mounting bracket assembly 100 includes a telescoping dual tubular support bar 110, an end-plate 120 at each end of the telescoping dual tubular support bar 110, and a metal electrical junction box 130 attached to the telescoping dual tubular support bar 110. The telescoping dual tubular support bar 110 includes two tubular members which have lateral axes that are parallel and which are oriented side-by-side. The end-plates 120 as shown in FIG. 1 do not include the height adjustable mechanism with the preset fasteners, however adding this mechanism to the end-plates 120 shown in FIG. 1 shall be understood to one skilled in the art. FIGS. 2 and 3 illustrate the two components of the telescoping dual tubular support bar 110, an inner member 112 and an outer member 114. An inside diameter of each tubular member of the outer member 114 is greater than an outside diameter of each tubular member of the inner member 112. The tubular members of the inner member 112 receive and slide inside the tubular members of the outer member 114 to provide the telescoping nature of the dual tubular support bar 110. FIG. 2 also shows the clamping component 140 that attaches the metal electrical junction box 130 to the telescoping dual tubular support bar 110. FIG. 3 shows the clamping component 140 as including a U-shaped bar 142 that slides inside grooves on the inside walls of the tubular members of the inner member 112 and outer member 114 of the telescoping dual tubular support bar 110. The U-shaped bar 142 includes two riveted fasteners 144 that attach the metal electrical junction box 130 to the U-shaped bar 142. Tightening the two riveted fasteners 144 secures the metal electrical junction box 130 to the dual tubular support bar 110 and prevents the metal electrical junction box 130 from sliding on the dual tubular support bar 110. In addition, the tightening also increases the vertical and horizontal strength of the dual tubular support bar 110. FIG. 4 shows the relationship between the telescoping dual tubular support bar 110 and the end-plates 120. Each end-plate 120 attaches to one end of either the inner member 112 or the outer member 114. The opposite end of the inner member 112 is then free to slide into the end of the outer member 114 opposite the other end-plate 120. FIGS. 5 and 6 illustrate the relationship between the metal electrical junction box 130 and the clamping component 140. The two riveted fasteners 144 each pass through an opening in the U-shaped bar 142 and an opening 134a in the metal electrical junction box 130 and are secured via a stopper (not shown) such as a nut. Alternatively, the installer may change the orientation of the metal electrical junction box 130 by passing the two riveted fasteners 144 through other openings 134b in the electrical junction box 130.

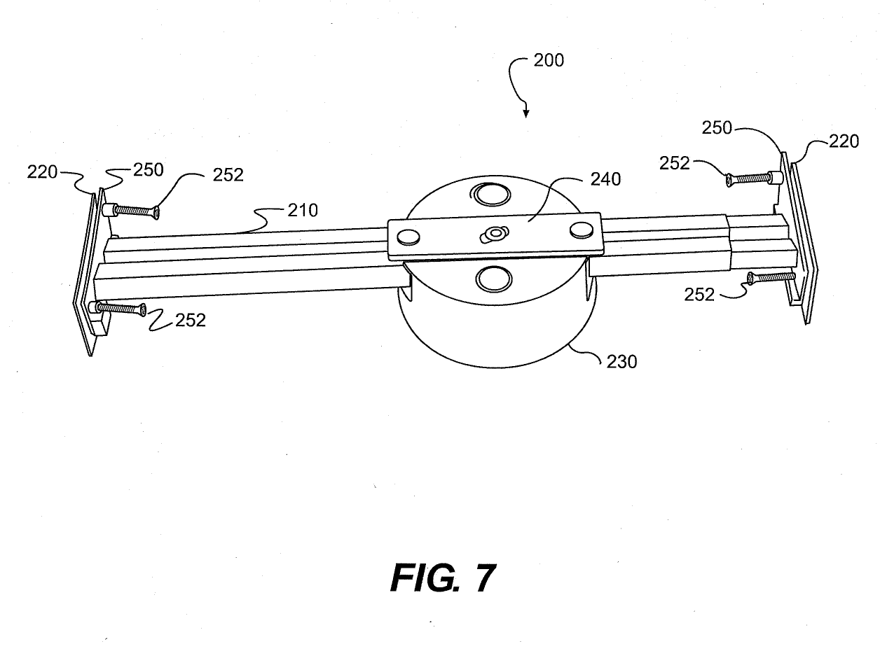

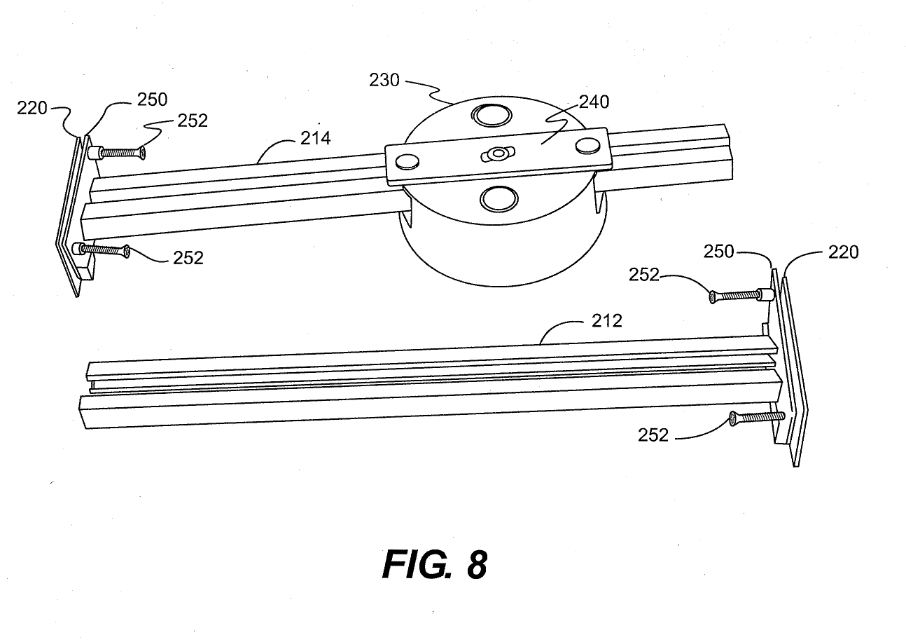

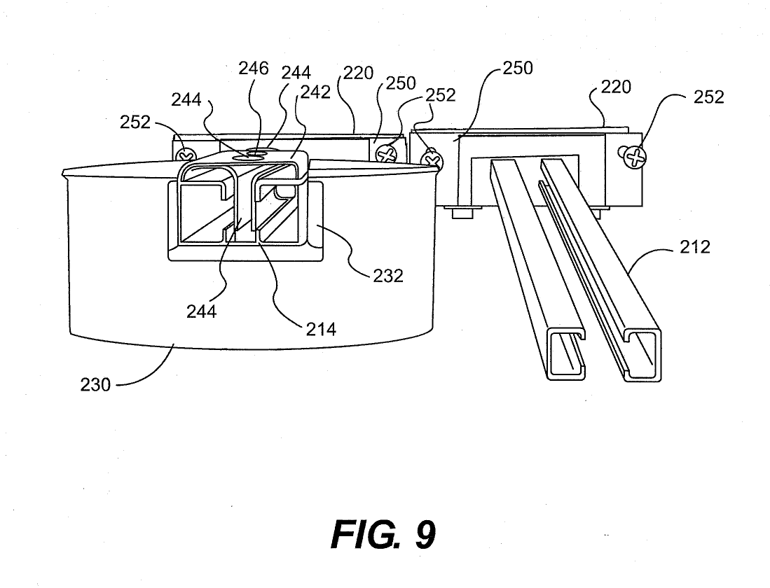

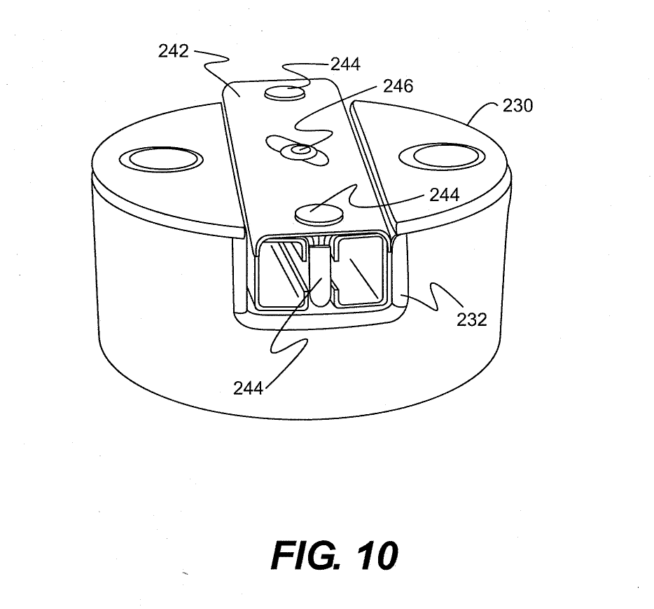

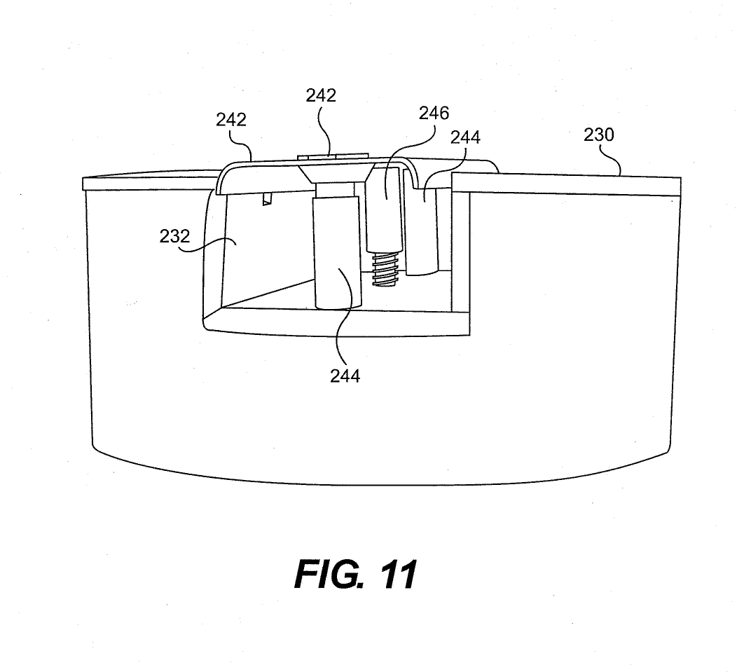

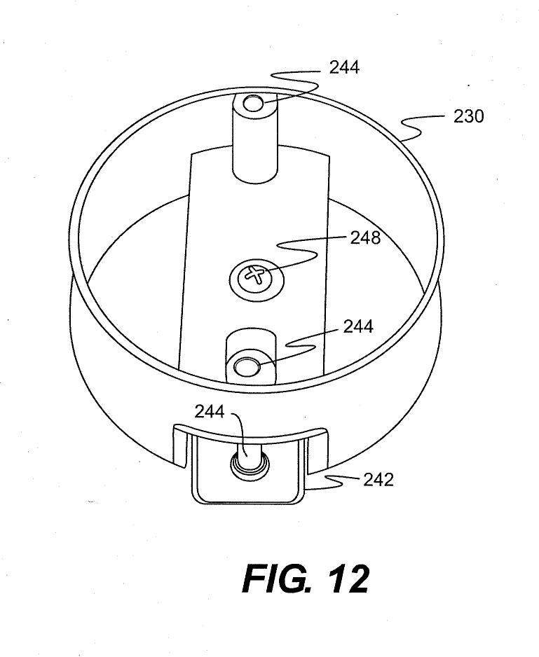

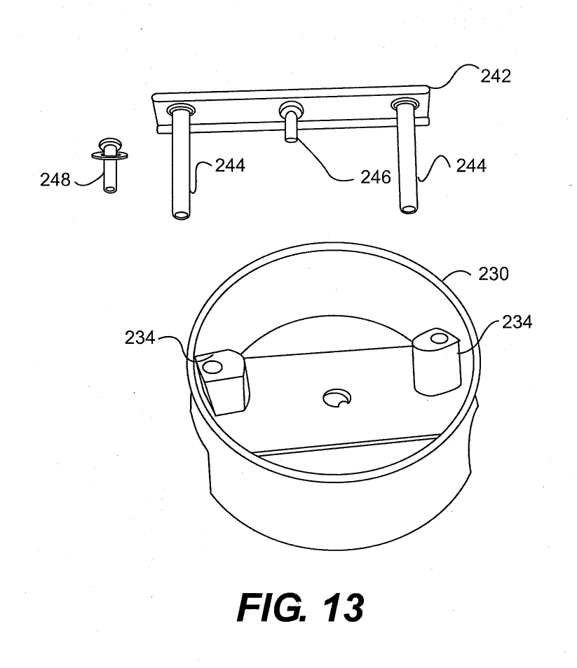

FIGS. 7-13 illustrate a second exemplary embodiment of the mounting bracket assembly of the present invention. As shown in FIG. 7, the mounting bracket assembly 200 includes a telescoping dual tubular support bar 210, an end-plate 220 at each end of the telescoping dual tubular support bar 210, and a plastic or polyvinyl chloride (PVC) electrical junction box 230 attached to the telescoping dual tubular support bar 210. The telescoping dual tubular support bar 210 includes two tubular members which have lateral axes that are parallel and which are oriented side-by-side. Attached to each end-plate 220 shown in FIG. 7 is a height adjustable mechanism 250 including preset fasteners 252. FIGS. 8 and 9 illustrate the two components of the telescoping dual tubular support bar 210, an inner member 212 and an outer member 214. An inside diameter of each tubular member of the outer member 214 is greater than an outside diameter of each tubular member of the inner member 212. The tubular members of the inner member 212 receive and slide inside the tubular members of the outer member 214 to provide the telescoping nature of the dual tubular support bar 210. FIG. 9 also shows the clamping component 240 that attaches the plastic or PVC electrical junction box 230 to the telescoping dual tubular support bar 210. The clamping component 240 includes a U-shaped bar 242 that slides outside the outer member 214 of the telescoping dual tubular support bar 210. The dual tubular support bar 210 slides in a channel 232 in the plastic or PVC electrical junction box 230 below the U-shaped bar 242. The channel 232 includes two shallow side walls and a lower wall. The shallow side walls are perpendicular to the lower wall. The lower surface of the lower wall of the channel is above the lower plane of the plastic or PVC electrical junction box 230 to form a cavity under the lower wall of the channel for housing electrical connections in the plastic or PVC electrical junction box 230. The width and depth of the channel are sufficient to receive the dual tubular support bar 210 and U-shaped bar 242. The U-shaped bar 242 includes two riveted fasteners 244 and a center riveted fastener 246. The center riveted fastener 246 attaches the plastic or PVC electrical junction box 230 to the U-shaped bar 242. The two riveted fasteners 244 pass through the plastic or PVC electrical junction box 230 to provide the threaded supports that attach the ceiling fixture (not shown) to the plastic or PVC electrical junction box 230. Tightening the plastic or PVC electrical junction box 230 to the U-shaped bar 242 secures the plastic or PVC electrical junction box 230 to the dual tubular support bar 210 and prevents the plastic or PVC electrical junction box 230 from sliding on the dual tubular support bar 210. In addition, the tightening also increases the vertical and horizontal strength of the dual tubular support bar 210. FIGS. 10 and 11 illustrate the relationship between the plastic or PVC electrical junction box 230 and the clamping component 240 including the channel 232 in the plastic or PVC electrical junction box 230 and the two riveted fasteners 244 and center riveted fastener 246 with the U-shaped bar 242. FIGS. 12 and 13 illustrate the interior of the plastic or PVC electrical junction box 230, the clamping component 240, and the threaded supports 244 that attach the ceiling fixture to the plastic or PVC electrical junction box 230.

The first and second exemplary embodiment of the mounting bracket assembly 100, 200 may be inserted in the space in a ceiling between two spaced beams, joists, studs, or the like. The telescoping dual tubular support bar 110, 210 spans the two spaced beams, joists, studs, or the like and secures to the two spaced beams, joists, studs, or the like by the use of the two endplates 120, 220. The telescoping dual tubular support bar 110, 210 provides added strength for securing a load (e.g., weight of a ceiling fixture) and stability (e.g., resistance against torsion). This is especially important with any fixture that is heavy or has rotating parts, such as a modern ceiling fan.

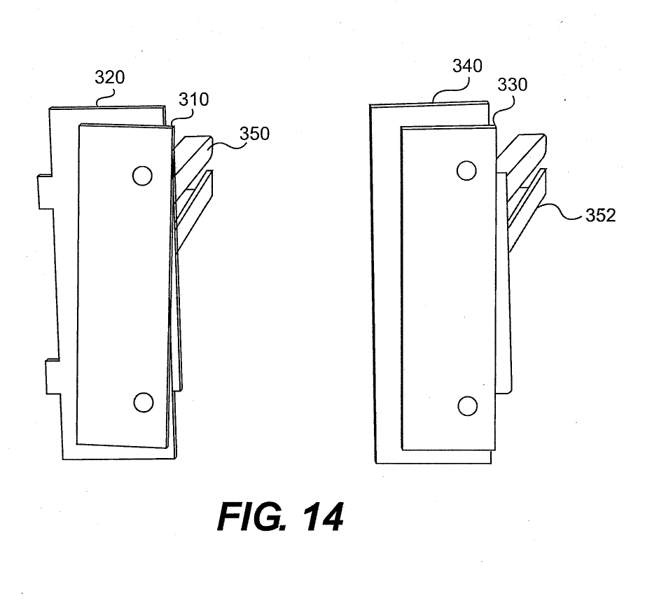

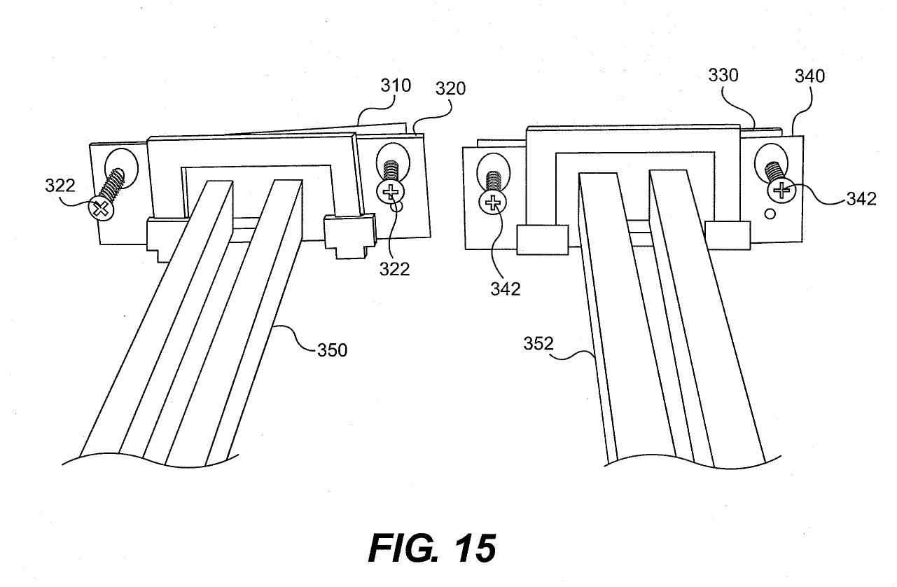

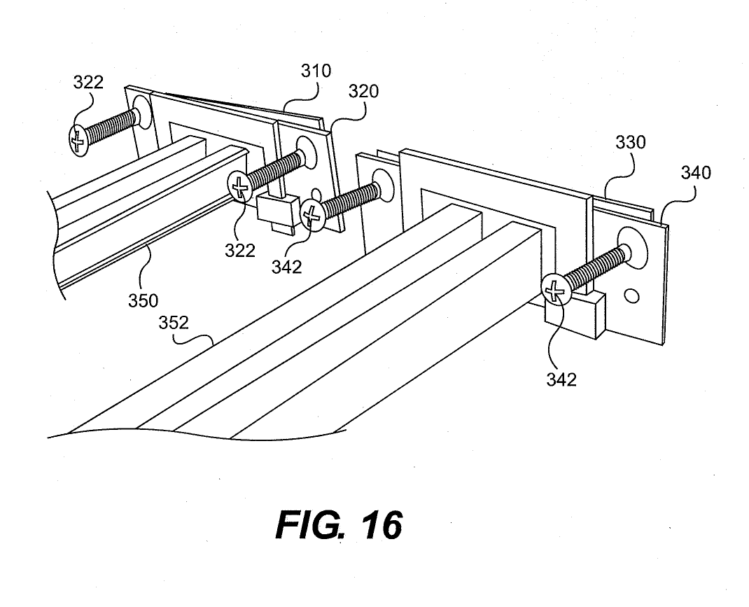

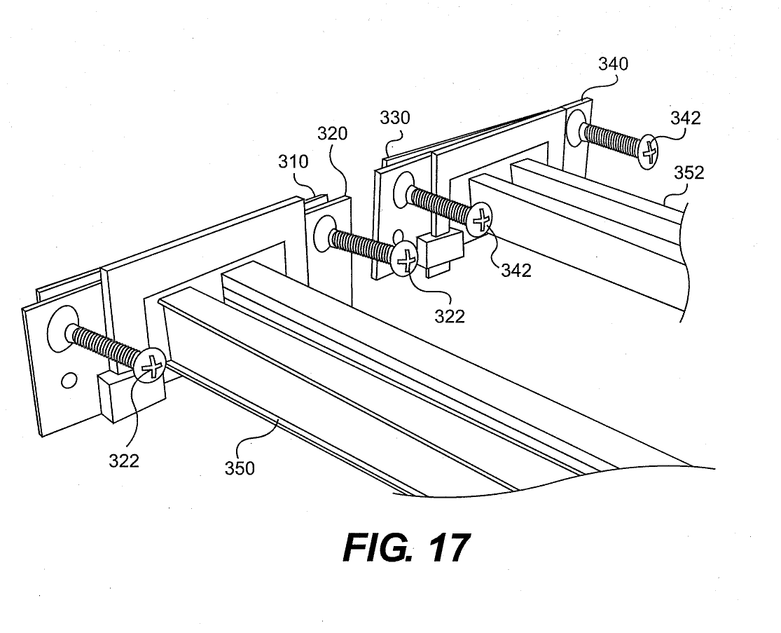

FIGS. 14-19 illustrate an exemplary embodiment of a height adjustable mechanism that attaches to the telescoping dual tubular support bar near the end-plate on the mounting bracket assembly of the present invention. FIG. 14 shows two embodiments of the height adjustable mechanism attached to the telescoping dual tubular support bar near the end-plate on the mounting bracket assembly. The left side of FIG. 14 shows the height adjustable mechanism 320 attached to the telescoping dual tubular support bar 350 near the end-plate 310. The height adjustable mechanism 320 is engaged to raise the height of the end-plate 310 which raises the height of the electrical junction box (not shown) that attaches to the telescoping dual tubular support bar 350 and allows the mounting bracket assembly to accommodate thinner finished drywall (e.g., ½ inch thick drywall). The right side of FIG. 14 shows the height adjustable mechanism 340 attached to the telescoping dual tubular support bar 352 near the end-plate 330. The height adjustable mechanism 340 is disengaged to use the standard height of the end-plate 330 which sets the height of the electrical junction box (not shown) that attaches to the telescoping dual tubular support bar 352 to the standard height and allows the mounting bracket assembly to accommodate thicker finished drywall (e.g., ⅝ inch thick drywall). FIGS. 15-17 show the two embodiments shown in FIG. 14 from other perspectives.

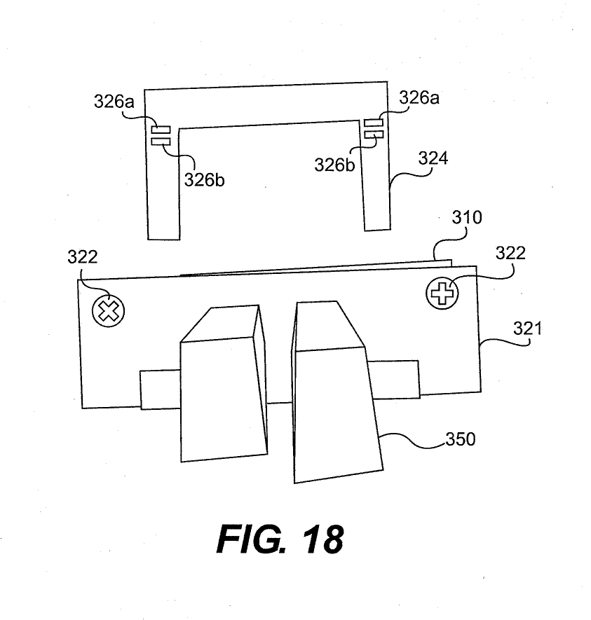

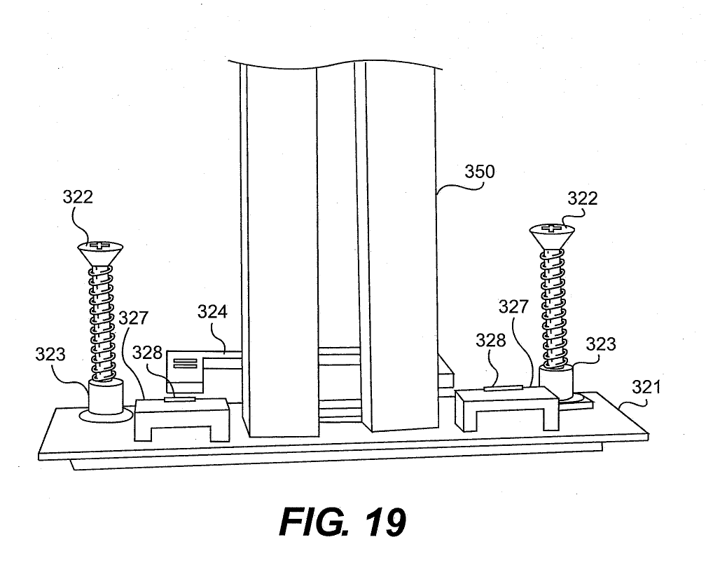

FIG. 18 shows the two components of the height adjustable mechanism 320 attached to the telescoping dual tubular support bar 350 near the end-plate 310, an overlay 321 and a slide 324. The left and right vertical members of the slide 324, as shown, include two slots 326a, 326b. When the installer moves the slide 324 to select the top slot 326a, the height adjustable mechanism 320 is engaged. When the installer moves the slide 324 to select the bottom slot 326b, the height adjustable mechanism 320 is disengaged. In other embodiments, the number of slots and the position of the slots will vary to accommodate various height adjustments for the height adjustable mechanism 320. FIG. 19 shows the guides 327 in the overlay 321 that receive the left and right vertical members of the slide 324. The left and right vertical members of the slide 324 pass through and the guides 327 and the notches 328 in the overlay 321 pass through one of the sets of slots 326a, 326b in the vertical members of the slide 324 to allow the installer to either engage or disengage the height adjustable mechanism 320.

The first and second embodiment of the mounting bracket assembly 100, 200 each may include the height adjustment mechanism 320. The height adjustable mechanism 320 contributes to the ease and convenience of installation of a ceiling fixture. The height adjustable mechanism 320 allows the mounting bracket assembly to be spaced at the appropriate distance from the ceiling, in a level fashion, and at the proper orientation (e.g., parallel to the ceiling level).

FIGS. 15-19 also illustrate an exemplary embodiment of preset fasteners 322, 342, such as screws, on the height adjustable mechanism 320, 340 attached to the telescoping dual tubular support bar 350 near the end-plate 310 on the mounting bracket assembly of the present invention. FIGS. 15-18 show several perspectives of the preset fasteners 322, 342 inserted in a circular boss 323 on each end of the overlay 321 and positioned to attach the mounting bracket assembly to the two spaced beams, joists, studs, or the like. FIG. 19 shows that the preset fasteners 322, 342 are preset in circular boss 323 of the overlay 321 that is perpendicular to the interior face of the overlay 321. The preset fasteners 322, 342 contribute to the ease and convenience of the installation process.

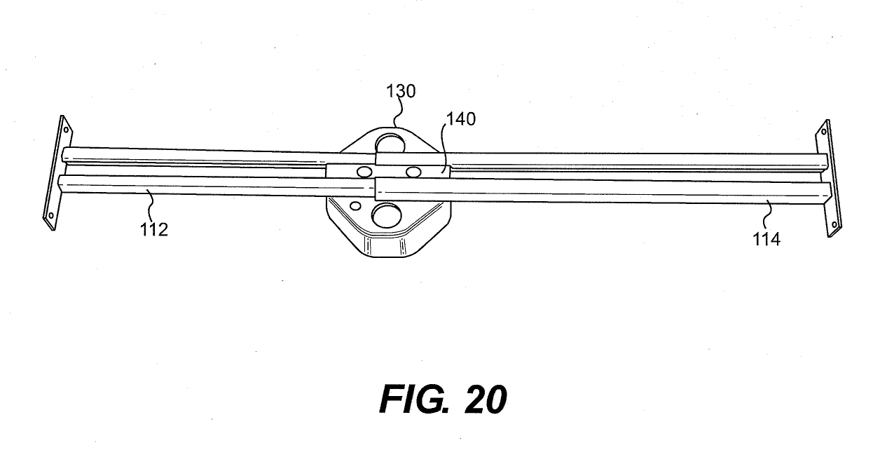

FIG. 20 illustrates an exemplary embodiment of the extended span capability of the mounting bracket assembly 100 illustrated in FIGS. 1-6. FIG. 20 shows the dual tubular support bar 110 which telescopes to accommodate a span between 14 and 26 inches between two spaced beams, joists, studs, or the like. The clamping component 140 that attaches the metal electrical junction box 130 to the dual tubular support bar 110 slides along the dual tubular support bar 110 to position the metal electrical junction box 130 at the most desirable position. When the attachment between the metal electrical junction box 130 and the dual tubular support bar 110 is tightened, the clamping component 140 also provides additional strength to the dual tubular support bar. The additional strength is maximized when the clamping component 140 is tightened on the portion of the dual tubular support bar that includes both the inner member 112 and the outer member 114 of the dual tubular support bar 110.

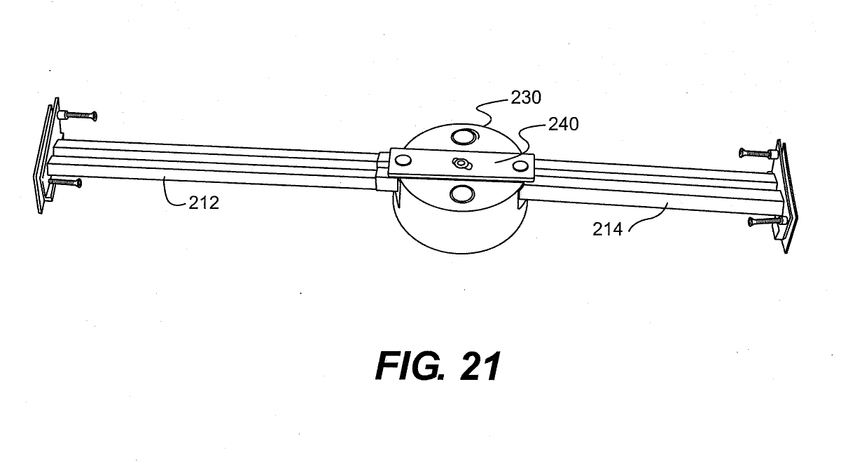

FIG. 21 illustrates an exemplary embodiment of the extended span capability of the mounting bracket assembly 200 illustrated in FIGS. 7-13. FIG. 21 shows the dual tubular support bar 210 which telescopes to accommodate a span between 14 and 26 inches between two spaced beams, joists, studs, or the like. The clamping component 240 that attaches the plastic or PVC electrical junction box 230 to the dual tubular support bar 210 slides along the dual tubular support bar 210 to position the plastic or PVC electrical junction box 230 at the most desirable position. When the attachment between the plastic or PVC electrical junction box 230 and the dual tubular support bar 210 is tightened, the clamping component 240 also provides additional strength to the dual tubular support bar 210. The additional strength is maximized when the clamping component 240 is tightened on the portion of the dual tubular support bar 210 that includes both the inner member 212 and the outer member 214 of the dual tubular support bar 210.

Although the disclosed exemplary embodiments describe a fully functioning mounting bracket assembly, the reader should understand that other equivalent exemplary embodiments exist. Since numerous modifications and variations will occur to those reviewing this disclosure, the mounting bracket assembly is not limited to the exact construction and operation illustrated and disclosed. Accordingly, this disclosure intends all suitable modifications and equivalents to fall within the scope of the claims.

I claim:

1. A mounting bracket assembly for hanging a heavy object in a ceiling area, comprising:
a support bar for spanning a distance between a pair of spaced joists, the support bar including two tubular members, a first tubular member having a lateral axis parallel to a lateral axis of a second tubular member, the second tubular member oriented to a side of the first tubular member, the support bar further comprising:
an inner member;
an outer member; and
a pair of end-plates, a first end-plate located at one end of the inner member and having a surface plane that is substantially perpendicular to a lateral axis of the inner member, and a second end-plate located at one end of the outer member and having a surface plane that is substantially perpendicular to a lateral axis of the outer member,
wherein at least two fasteners pass through openings in the end-plates to attach the support bar to the pair of spaced joists; and
a clamping component further comprising:
a clamping bar; and
at least one fastener that passes through an opening in the clamping bar and an opening in an electrical junction box,
wherein at least a portion of the support bar is positioned between the clamping bar and the electrical junction box, and
wherein tightening said at least one fastener that passes through the opening in the clamping bar secures the electrical junction box to the support bar.

2. The mounting bracket assembly of claim 1, wherein an inside diameter of each tubular member of the outer member of the support bar is greater than an outside diameter of each tubular member of the inner member of the support bar, and wherein the tubular members of the outer member of the support bar receive the tubular members of the inner member of the support bar to allow the support bar to telescope along its lateral axis.

3. The mounting bracket assembly of claim 2, wherein the distance between the pair of spaced joists is between 14 and 26 inches.

4. The mounting bracket assembly of claim 1, wherein the electrical junction box is a metal electrical junction box.

5. The mounting bracket assembly of claim 4, wherein a side wall of the first tubular member nearest the second tubular member includes a first groove, and a side wall of the second tubular member nearest the first tubular member includes a second groove, wherein the clamping bar has a U-shape to allow the first groove to receive a first side of the clamping bar, the second groove to receive a second side of the clamping bar, and wherein a space between the first tubular member and the second tubular member receive the fasteners that pass through the openings in the clamping bar thereby allowing the clamping bar to slide along a lateral axis of the support bar.

6. The mounting bracket assembly of claim 5, wherein positioning the clamping component on a portion of the support bar that includes the inner member and the outer member increases the strength of the support bar.

7. The mounting bracket assembly of claim 1, wherein the electrical junction box is a plastic or PVC electrical junction box.

8. The mounting bracket assembly of claim 7, the electrical junction box further comprising:
an upper wall;
a side wall;
a lower plane for hanging the heavy object beneath the side wall; and
a channel in the upper wall, the channel having two shallow side walls and a lower wall, the shallow side walls perpendicular to the lower wall, a lower surface plane of the lower wall of the channel above the lower plane of the electrical junction box,
wherein the channel receives the support bar and the clamping bar,
wherein the support bar is positioned between the clamping bar and the lower wall of the channel, and
wherein a space between the first tubular member and the second tubular member receives said at least one fastener that passes through the opening in the clamping bar thereby allowing the clamping bar to slide along a lateral axis of the support bar.

9. The mounting bracket assembly of claim 8, wherein positioning the clamping component on a portion of the support bar that includes the inner member and the outer member increases the strength of the support bar.

10. The mounting bracket assembly of claim 1, further comprising:
an overlay for each end-plate, the overlay including:
an opening for receiving the inner member or the outer member of the support bar; and
an opening for receiving each fastener that attaches the support bar to the pair of spaced joists.

11. The mounting bracket assembly of claim 10, the overlay further including:
a circular boss around the opening for receiving each fastener,
wherein the circular boss holds the fastener and aligns the fastener with the opening in the end-plate thereby simplifying the attachment of the support bar to the pair of spaced joists.

12. The mounting bracket assembly of claim 10, the overlay further comprising:
a slide comprising:
a left vertical member;
a right vertical member;
a horizontal member that connects an upper end of the left vertical member and an upper end of the right vertical member; and
at least two sets of slots in the upper end of the vertical members, each set of slots including a left slot in the left vertical member and a right slot in the right vertical member;
two guides positioned at a lower edge of the overlay, a left guide for receiving the left vertical member, and a right guide for receiving the right vertical member; and
two notches positioned near an upper edge of the overlay, the two notches positioned to insert into one of the sets of slots.

13. The mounting bracket assembly of claim 12, wherein inserting the two notches into a lower of the sets of slots disengages the slide thereby using a standard height end-plate.

14. The mounting bracket assembly of claim 12, wherein inserting the two notches into an upper of the sets of slots engages the slide thereby increasing the height of the end-plate.

15. A mounting bracket assembly for hanging a heavy object in a ceiling area, comprising:
a support bar for spanning a distance between a pair of spaced joists, the support bar further comprising:
an inner member;
an outer member; and
a pair of end-plates, a first end-plate located at one end of the inner member and having a surface plane that is substantially perpendicular to a lateral axis of the inner member, and a second end-plate located at one end of the outer member and having a surface plane that is substantially perpendicular to a lateral axis of the outer member,
wherein at least two fasteners pass through openings in the end-plates to attach the support bar to the pair of spaced joists;
a clamp attached to an electrical junction box, the clamp securing the electrical junction box to the support bar; and
an overlay for each end-plate, the overlay further comprising:
an opening for receiving the inner member or the outer member of the support bar;
an opening for receiving each fastener that attaches the support bar to the pair of spaced joists;
a slide, comprising:
a left vertical member;
a right vertical member;
a horizontal member that connects an upper end of the left vertical member and an upper end of the right vertical member; and
at least two sets of slots in the upper end of the vertical members, each set of slots including a left slot in the left vertical member and a right slot in the right vertical member;
two guides positioned at a lower edge of the overlay, a left guide for receiving the left vertical member, and a right guide for receiving the right vertical member; and
two notches positioned near an upper edge of the overlay, the two notches positioned to insert into one of the sets of slots.

16. The mounting bracket assembly of claim 15, wherein inserting the two notches into a lower of the sets of slots disengages the slide thereby using a standard height end-plate.

17. The mounting bracket assembly of claim 15, wherein inserting the two notches into an upper of the sets of slots engages the slide thereby increasing the height of the end-plate.
